(19) United States
(12) Patent Application Publication
(10) Pub. No.: US 2017/0098926 A1
(43) Pub. Date: Apr. 6, 2017

(54) WIRE-ROUTING ASSEMBLY FOR AN INJECTOR HARNESS

(71) Applicant: Caterpillar Inc., Peoria, IL (US)

(72) Inventors: Carl M. Wisniewski, Normal, IL (US); Jayant K. Roplekar, Peoria, IL (US); Seth C. Studnicka, Chillicothe, IL (US); Craig Bolyard, New Braunfels, TX (US); Brandon Neuhoff, Peoria, IL (US)

(73) Assignee: Caterpillar Inc., Peoria, IL (US)

(21) Appl. No.: 15/386,469

(22) Filed: Dec. 21, 2016

(51) Int. Cl. H02G 3/04; B60R 16/02; H01B 7/00

(52) U.S. Cl. CPC H02G 3/0456; H01B 7/0045; B60R 16/0215

(57) ABSTRACT

The disclosure provides a wire-routing assembly for routing an injector harness along an inner portion of a valve cover base in an engine. The wire-routing assembly includes a guard, which in turn includes an attachment portion and a routing portion. The attachment portion includes a first end, a second end, and an intermediate section. The first end and the second end of the attachment portion are attached to the inner portion of the valve cover base. The routing portion extends from the intermediate section in a direction substantially perpendicular to the attachment portion. The routing portion defines a clearance space between the routing portion and the inner portion of the valve cover base. At least a portion of the injector harness is routed through the clearance space, such that the routing portion avoids contact between a valve spring and the injector harness.

### TECHNICAL FIELD

The present disclosure generally relates to a wire-routing assembly for an injector harness in an engine. More particularly, the present disclosure relates to a guard of the wire-routing assembly, which routes and guards at least a portion of the injector harness in the engine.

### BACKGROUND

Engines, such as internal combustion engines, are commonly known to employ a number of fuel injectors. Each fuel injector is electrically connected to and controlled by a control unit. An injector harness (a bunch of a number of electrical wires) is generally employed to facilitate electrical connection between the fuel injectors and the control unit. At least a portion of the injector harness is routed along an inner portion of a valve cover base. A wire-routing assembly is typically employed to route the portion of the injector harness along the inner portion of the valve cover base.

Conventionally, the wire-routing assembly includes a clip installed on the inner portion of the valve cover base. The clip includes a cavity, through which the portion of the injector harness is routed. A valve spring is further positioned proximal to the clip and adjacent to the portion of the injector harness. A minimal clearance is defined between the valve spring and the portion of the injector harness. While in operation, the valve spring is likely to contact the portion of the injector harness. This may cause damage to the injector harness, resulting in operational failure of the fuel injectors.

U.S. Pat. No. 6,688,679 describes an assembly (wire-routing assembly) for supporting a bundle of wires. The assembly includes an elastically deformable channel shaped shell positioned in an elongated housing. The bundle of wires are routed and supported within the shell of the assembly. Although, the '679 reference discloses the assembly for routing and supporting the bundle of wires, the reference does not provide a solution to guard the injector harness from the valve spring.

Hence, there is a need for an improved wire-routing assembly to guard the injector harness, while routing the injector harness along the inner portion of the valve cover base in the engine.

### SUMMARY OF THE DISCLOSURE

Various aspects of the present disclosure provide a wire-routing assembly for routing an injector harness along an inner portion of a valve cover base in an engine. The wire-routing assembly includes a guard. The guard includes an attachment portion and a routing portion. The attachment portion includes a first end, a second end, and an intermediate section. The first end and the second end of the attachment portion are attached to the inner portion of the valve cover base. The routing portion extends from the intermediate section in a direction substantially perpendicular to the attachment portion. The routing portion defines a clearance space between the routing portion and the inner portion of the valve cover base. At least a portion of the injector harness is routed through the clearance space between the routing portion and the valve cover base, such that the routing portion of the guard avoids contact between a valve spring and the injector harness.

### BRIEF DESCRIPTION OF THE DRAWINGS

FIG. 1 is a perspective view of an engine, in accordance with the concepts of the present disclosure;

FIG. 2 is a perspective view of a portion of the engine of FIG. 1, illustrating a wire-routing assembly of the engine, in accordance with the concepts of the present disclosure;

FIG. 3 is a bottom view of the portion of the engine of FIG. 1, illustrating the wire-routing assembly, in accordance with the concepts of the present disclosure;

FIG. 4 is a perspective view of the wire-routing assembly of FIG. 2, illustrating a guard and two cable straps of the wire-routing assembly, in accordance with the concepts of the present disclosure; and

FIG. 5 is a perspective view of the guard of the wire-routing assembly of FIG. 4, in accordance with the concepts of the present disclosure.

### DETAILED DESCRIPTION

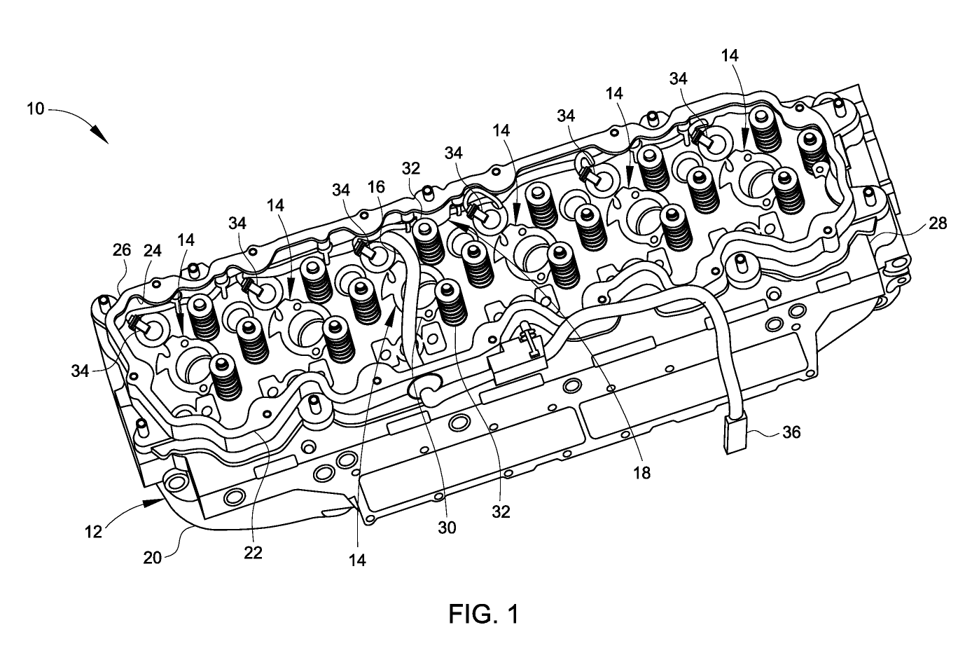

Referring to FIG. 1, there is shown a perspective view of an exemplary engine 10 of a machine (not shown). For better understanding and clarity purposes, one or more components of the engine 10 are not shown in FIG. 1. The machine (not shown) may embody any vehicle employing the engine 10, such as but not limited to, an excavator, a wheel loader, a track-type tractor, an off-highway truck, and a shovel. Applicability to various other stationary machines employing the engine 10, may also be contemplated. The engine 10 includes an engine housing 12, six cylinder arrangements 14, an injector harness 16, and a wire-routing assembly 18.

The engine housing 12 houses and supports various other components of the engine 10. The engine housing 12 includes an engine block 20, a valve cover base 22, and a valve cover (not shown). The valve cover base 22 includes an inner portion 24 and an exterior portion 26. The valve cover base 22 is installed on a top portion 28 of the engine block 20. The valve cover (not shown) is further installed on the valve cover base 22. With such arrangement, the engine housing 12 houses and supports the cylinder arrangements 14, the injector harness 16, and the wire-routing assembly 18 of the engine 10.

The cylinder arrangements 14 are installed in an in-line layout, within the engine block 20 of the engine housing 12. Each cylinder arrangement 14 includes an injector (not shown), a combustion cylinder 30, and at least one valve spring 32. The injector (not shown) injects an air-fuel mixture into the combustion cylinder 30, where the air-fuel mixture is combusted to generate engine power. The injector (not shown) is electrically connected to and controlled by a control unit (not shown), via the injector harness 16. Although, the present disclosure describes usage of six cylinder arrangements 14 in the engine 10, any number of the cylinder arrangements 14 may be contemplated. Although, the present disclosure describes the in-line layout of the cylinder arrangements 14, various other layouts of the cylinder arrangements 14 may also be contemplated. For example, a V-layout of the cylinder arrangements 14 may also be used.

The injector harness 16 is an arrangement of a number of electrical wires, which facilitates an electric connection between the injectors (not shown) and the control unit (not shown). The injector harness 16 includes six injector-connection ends 34 and a controller-connection end 36. The injector-connection ends 34 of the injector harness 16 are electrically connected to the injector (not shown) of each of the cylinder arrangements 14. The controller-connection end 36 of the injector harness 16 is electrically connected to the control unit (not shown). To facilitate such arrangement, at least a portion of the injector harness 16 is routed along the inner portion 24 of the valve cover base 22 and is positioned in close proximity to one of the valve springs 32.

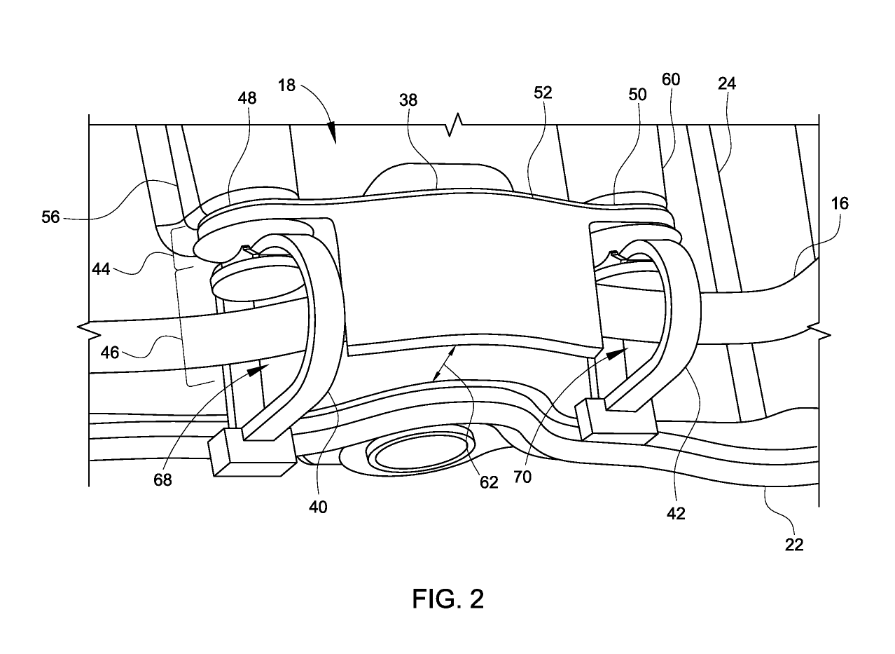

Referring to FIGS. 2, 3, and 4, there is shown the wire-routing assembly 18 of the engine 10. The wire-routing assembly 18 is employed to guard the portion of the injector harness 16, while routing the portion of the injector harness 16 along the inner portion 24 of the valve cover base 22. The wire-routing assembly 18 includes a guard 38, a first cable strap 40, and a second cable strap 42.

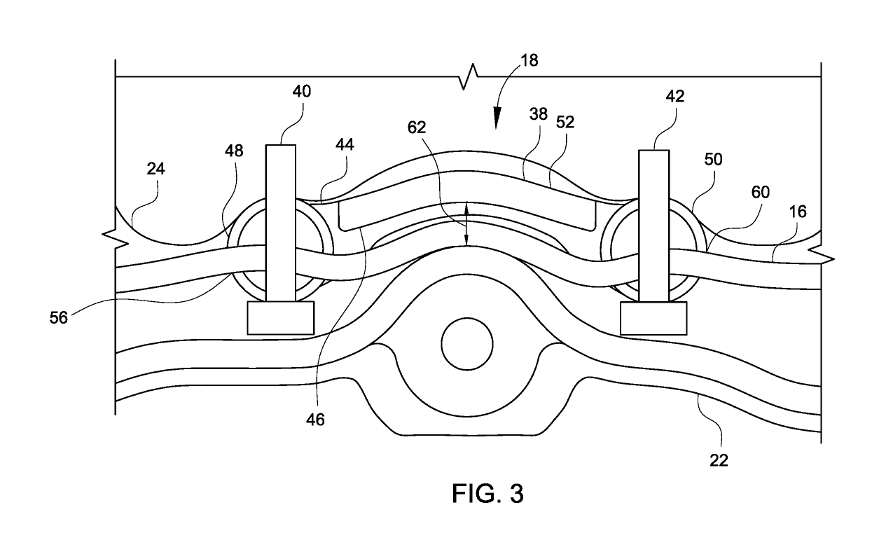

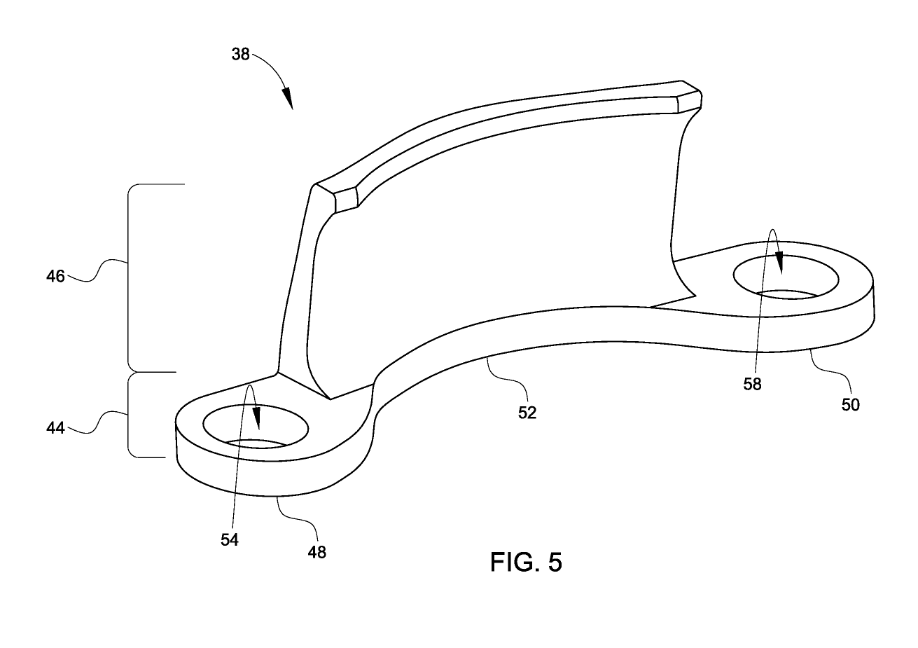

Referring to FIGS. 2, 3, 4, and 5, the guard 38 of the wire-routing assembly 18 includes an attachment portion 44 and a routing portion 46. The attachment portion 44 of the guard 38 includes a first end 48, a second end 50, and an intermediate section 52 extending between the first end 48 and the second end 50. The first end 48 includes a first hole 54 (FIG. 5). The first end 48 is attached to a first attachment section 56 (FIGS. 2 and 3) of the inner portion 24 of the valve cover base 22, via the first cable strap 40. The second end 50 includes a second hole 58 (FIG. 5). The second end 50 is attached to a second attachment section 60 (FIGS. 2 and 3) of the inner portion 24 of the valve cover base 22, via the second cable strap 42. Structure and arrangement of the first cable strap 40 and the second cable strap 42, will be described later in details.

The routing portion 46 of the guard 38 extends from the intermediate section 52 of the attachment portion 44 in a direction substantially perpendicular to the attachment portion 44. The routing portion 46 defines a clearance space 62 (FIGS. 2 and 3) between the routing portion 46 and the inner portion 24 of the valve cover base 22. With such arrangement, the portion of the injector harness 16 is extended through the clearance space 62 (FIGS. 2 and 3) between the routing portion 46 and the inner portion 24. Therefore, the routing portion 46 avoids contact between the valve spring 32 and the injector harness 16.

Referring back to FIGS. 2, 3, and 4, there is shown the first cable strap 40 and the second cable strap 42. The first cable strap 40 and the second cable strap 42 are self-locking straps, employed to mount the guard 38 on the inner portion 24 of the valve cover base 22.

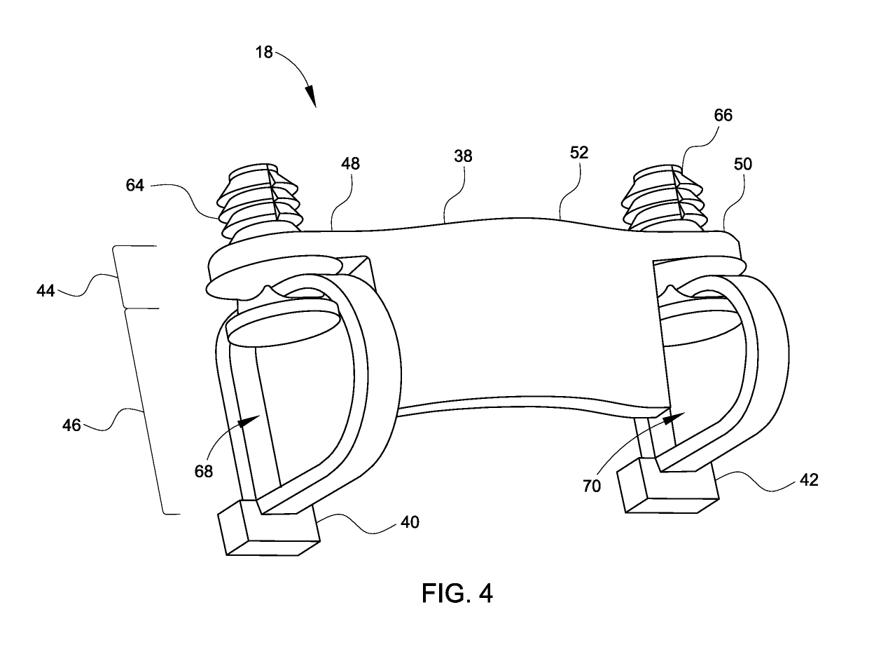

The first cable strap 40 is a self-locked looped strap that includes a first screw-shaped member 64 (FIG. 4). The first screw-shaped member 64 (FIG. 4) of the first cable strap 40 extends through the first hole 54 in the first end 48, to fittingly engage with the first attachment section 56 of the inner portion 24 of the valve cover base 22. Therefore, the first cable strap 40 fixedly attaches the first end 48 of the attachment portion 44 to the first attachment section 56 of the inner portion 24 of the valve cover base 22.

Similar to the first cable strap 40, the second cable strap 42 includes a second screw-shaped member 66 (FIG. 4). The second screw-shaped member 66 (FIG. 4) of the second cable strap 42 extends through the second hole 58 in the second end 50, to fittingly engage with the second attachment section 60 of the inner portion 24 of the valve cover base 22. Therefore, the second cable strap 42 fixedly attaches the second end 50 of the attachment portion 44 to the second attachment section 60 of the inner portion 24 of the valve cover base 22. Such arrangement of the first cable strap 40 and the second cable strap 42 mounts the guard 38 on the inner portion 24 of the valve cover base 22.

### INDUSTRIAL APPLICABILITY

In operation, the injector harness 16 of the engine 10 electrically connects the injectors (not shown) to the control unit (not shown). To facilitate such connection, the portion of the injector harness 16 is routed along the inner portion 24 of the valve cover base 22, proximal to the valve spring 32 of the cylinder arrangement 14.

The wire-routing assembly 18 is installed on the inner portion 24 of the valve cover base 22, to route and guard the portion of the injector harness 16. More specifically, the guard 38 of the wire-routing assembly 18 is installed on the inner portion 24 of the valve cover base 22. For such installation, the guard 38 is initially positioned, such that the first end 48 abuts with the first attachment section 56 and the second end 50 abuts with the second attachment section 60 of the inner portion 24 of the valve cover base 22. Thereafter, the first cable strap 40 and the second cable strap 42, respectively fixedly attaches the guard 38 to the inner portion 24 of the valve cover base 22. More specifically, the first screw-shaped member 64 of the first cable strap 40 is extended through the first hole 54 in the first end 48, to fittingly engage with the first attachment section 56 of the inner portion 24 of the valve cover base 22. Similarly, the second screw-shaped member 66 of the second cable strap 42 is extended through the second hole 58 in the second end 50, to fittingly engage with the second attachment section 60 of the inner portion 24 of the valve cover base 22. Therefore, the guard 38 is installed on the inner portion 24 of the valve cover base 22.

Furthermore, as the guard 38 is installed on the inner portion 24 of the valve cover base 22, the clearance space 62 is defined between the routing portion 46 and the inner portion 24 of the valve cover base 22. The portion of the injector harness 16 is routed sequentially through a loop 68 of the first cable strap 40, the clearance space 62 between the routing portion 46 and the inner portion 24 of the valve cover base 22, and a loop 70 of the second cable strap 42 of the wire-routing assembly 18.

Routing of the injector harness 16 through the clearance space 62 avoids any contact between the valve spring 32 and the injector harness 16. Therefore, the injector harness 16 is prevented from any damage caused by contact with the valve spring 32. With such wire-routing assembly 18, a work-life of the injector harness 16 is increased. This reduces chances of operational failures of the injectors (not shown), resulting in increased reliability of the engine 10.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claim(s) and any equivalents thereof.

What is claimed is:

1. A wire-routing assembly for routing an injector harness along an inner portion of a valve cover base in an engine, the wire-routing assembly comprising:
a guard, including:
an attachment portion having a first end attached to the inner portion of the valve cover base, a second end attached to the inner portion of the valve cover base, and an intermediate section extending between the first end and the second end; and
a routing portion extending from the intermediate section in a direction substantially perpendicular to the attachment portion, and defining a clearance space between the routing portion and the inner portion of the valve cover base,
wherein at least a portion of the injector harness is routed through the clearance space between the routing portion and the valve cover base, such that the routing portion of the guard avoids contact between a valve spring and the injector harness.
